(19) United States
(12) Patent Application Publication
(10) Pub. No.: US 2015/0375108 A1
(43) Pub. Date: Dec. 31, 2015

(54) POSITION SENSING APPARATUS AND METHOD

(71) Applicant: DEAKIN UNIVERSITY, Victoria (AU)

(72) Inventor: Pubudu Nishantha PATHIRANA, Waurn Ponds (AU)

(21) Appl. No.: 14/767,973

(22) PCT Filed: Feb. 4, 2014
(86) PCT No.: PCT/AU2014/000078

§ 371 Date: Aug. 14, 2015

(30) Foreign Application Priority Data
Feb. 14, 2013 (AU) 2013900479

(51) Int. Cl. A63F 13/235; G06F 3/01; A63F 13/825; A63F 13/211

(52) U.S. Cl. CPC A63F 13/235; A63F 13/211; G06F 3/011; A63F 13/825

(57) ABSTRACT

Method and apparatus for detecting position of a part of the body of a user. A wearable emitter unit (16) is worn by the user, the emitter unit being worn by at a location adjacent the part of a body of the user. A radio signal propagated from the emitter unit (16) is received by a receiving unit (14), at antennae (52). Differences in times of arrival of the radio signal at ones of four different pairs of the antennae (52) are determined and, from the detected differences, the three-dimensional position of the emitter unit, and thus the part of the body of the user, is determined.

### FIELD OF THE INVENTION

This invention relates to a position sensing apparatus and method.

### BACKGROUND OF THE INVENTION

Human motion analysis systems have numerous applications in e.g. modern health-care, entertainment and sports industries. In many applications, visual information (video camera) or micro electro mechanical systems (MEMS) sensor based capturing systems are employed as primary means of tracking the motion of a person. For instance, gaming controllers such as that marketed under the trade name Wii use inertial measurement techniques (i.e. accelerometers) to capture the motion patterns (see U.S. Pat. No. 7,774,155). Other gaming devices use vision based motion capture systems, for example that marketed under the trade name Kinetic uses video and infrared imaging techniques to capture the motion of people in front of a gaming controller, and a motion tracking controller marketed under the trade name Sony PlaystationMove uses visual and inertial measurement (acceleration, gyroscopic motion and magnetic field measurement) data to capture the player arm (or a hand held controller) in the field of view of the TV mount camera (see US 2010/0105475 A1).

Although visual information based motion capture has been successfully applied in the entertainment the industry, it requires special studio locations and specialized costume for capturing unique motion patterns of different segments of the body. In contrast, the MEMS based approach can be used to capture motion data in non-standard settings (i.e. in natural environments), and has attracted interest in health-care applications, in particular for patients with Parkinson's disease and patients in the process of rehabilitation from stroke or accident.

Inertial sensor based localization systems are inherently associated with error accumulation over time. Significant research has been directed to overcoming such error accumulation via filtering and estimation methods. On the other hand, measurements from Time of Arrival (ToA) or Time-Difference-of-Arrival (TDoA) based emitter localization systems were not used in such human motion tracking systems. Such Time-delay measurement systems are used in the aerospace industry (Radar system), health-care industry (Ultra-sound scanning machines) and Global Positioning System (GPS) navigation systems. Among these, Radar and Ultra-sonic ranging methods are using the time-of-flight (ToA) and Doppler phase shift of the reflected signal and the GPS systems are using TDoA approach to resolve the position of the receiver.

Overall, although the gaming systems above described may be able relatively simple and inexpensive, and may be able to sense position or movement of a human, they are not generally capable of doing this with a precision that may be needed in, for example, diagnosis of medical conditions affecting humans. More complex systems as above described may perhaps be suitable, but these are generally expensive and unwieldy.

### SUMMARY OF THE INVENTION

According to one aspect of the invention there is provided an apparatus for detecting position of a part of the body of a human user, the apparatus having a wearable emitter unit adapted to be worn by the user at a location adjacent said part of the body of the user, having a radio transmitter for generating and propagating radio signal from the emitter unit, and a receiver unit, the receiver unit having:
a) radio receiver means for receiving radio signal from the emitter unit;
b) at least five spatially separated antennae for receiving the radio signal, not all disposed in a single plane; and
c) computing means for detecting differences between times of arrival of said signal at ones of four different pairs of said antennae and determining from the detected differences the three-dimensional position of said emitter unit with respect to the receiver unit.

The invention also provides a method of detecting position of a part of the body of a human user, in which a wearable emitter unit and a receiver unit are worn by the user, the method including:
a) propagating a radio signal from the emitter unit;
b) receiving the propagated radio signal at least five antennae of the receiver unit, not all antennae being in the same plane,
c) determining the differences in times of arrival of said radio signal at ones of four different pairs of said antennae; and
d) determining from the detected differences the three-dimensional position of said emitter unit with respect to the receiver unit.

The invention also provides a computer program including a plurality of instructions for execution by one or more processors of a computer system, said program when executed by the one or more processors cause the computer system to perform the above-described method.

The invention also provides a non-transitory computer readable data storage including the above computer program stored thereon.

The invention is further described by way of example only with reference to the accompanying drawings.

### BRIEF DESCRIPTION OF THE DRAWINGS

FIG. 1 is a diagram showing a human user fitted with apparatus formed in accordance with the invention, having a receiver unit and several emitter units;

FIG. 2 is a diagrammatic front perspective view of the receiver unit of the apparatus of FIG. 1 incorporated into a wearable belt;

FIG. 3 is a diagrammatic rear perspective view of the receiver unit of FIG. 2;

FIG. 4 is a diagrammatic face view of an antenna structure of the receiver unit of FIGS. 2 and 3;

FIG. 5 is a diagrammatic perspective representation showing the arrangement of antennae in the receiver unit of FIGS. 2 and 3;

FIG. 6 is diagrammatic representation of an emitter unit of the apparatus of FIG. 1, and some parts of the receiver unit of FIGS. 2 and 3;

FIG. 7 is block diagram of components of the emitter unit of FIG. 6;

FIG. 8 is a block diagram of components of the receiver unit of FIGS. 1 and 6;

FIG. 9 is block diagram of components of an offset signal measurement unit of the receiver unit of the invention, for determining RF phase offset and making I/Q modulation measurements;

FIG. 10 is a block diagram of a reference offset signal measurement unit incorporated into the receiver unit of the invention;

FIG. 11 is a waveform diagram illustration signal transmission from emitter units of the invention;

FIG. 12 is a set of diagrams illustrating principles of phase determination applicable in an embodiment of the invention;

FIG. 13 is diagram showing components for communications between a receiver unit and emitter units of the invention;

FIG. 14 is a flow chart illustrating signal processing in an embodiment of the invention;

FIG. 15 is a flow chart illustrating further signal processing in an embodiment of the invention; and

FIG. 16 shows reference frames used in describing operation of preferred embodiments of the invention.

### DETAILED DESCRIPTION OF THE PREFERRED EMBODIMENTS

The apparatus 10 depicted in the drawings is designed to provide information as to the relative locations of parts of the body of a human user 12. The apparatus 10 is wearable in that the various components are incorporated into units that are worn by the user in use of the apparatus 10. For this purpose, these units are provided with means for attaching or securing them in fixed locations relative to the user's body, e.g. directly, or to the user's clothing. The units include a receiver unit 14 and six emitter units 16, 18, 20, 22, 24 and 26. Unit 14 is in use positioned at the user's waist, units 16, 18 at locations adjacent respective shoulders of the user, units 20, 22 at locations adjacent respective user wrists and units 24, 26 at respective ankles of the user. Receiver unit 14 includes a belt 15, positionable to encircle the user's waist, e.g. with elements of a hook and loop connector 51 (FIG. 2) at opposite ends, joinable to form a loop around the user's waist. Units 20, 22, 24 and 26 may be attached to the user using similarly formed wrist and ankle bands 40, 42, 44 and 46, and units 16, 18 may be affixable by hook and loop connectors 48, 50 one element of which is on the respective unit and the other of which is affixed to the user's clothing at the respective shoulder.

FIGS. 2 and 3 show receiver elements 30, 32, 34, 36 incorporated into the receiver unit 14. Each has two radio antennae 52. The elements 32, 36 at the front and back and to one side of the user are spaced from each other in the front to rear direction and the elements 30, 34 at front and back and to the other side of the user are likewise spaced from each other in the front to rear direction.

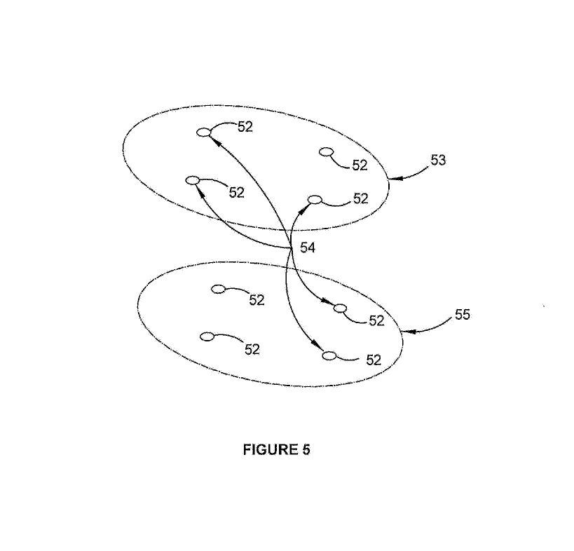

The elements 30, 32, 34, 36 are generally arranged in a horizontal plane when the user is standing. More particularly, however, first ones of the antennae 52 in each of the receiver elements 30-36 are substantially coplanar, being in a first plane 53 (FIG. 5), and the second ones of the antenna 52 in each receiver element are disposed in another common plane 55 spaced from and below that in which first antennae are disposed. These planes are generally horizontal when the user is standing.

This embodiment of the invention is intended for identifying locations in three dimensions, for which it is necessary that at least five of the antennae 52 be utilized, but not all the antennae need be utilized. In particular, any five may be utilized so long as no common plane can be found in which those used all lie. By way of example, the following assumes that three of the antenna in the upper one of the mentioned planes, plane 53, are used together with two in the other, lower, plane 55, these forming an array 54, schematically illustrated in FIG. 5.

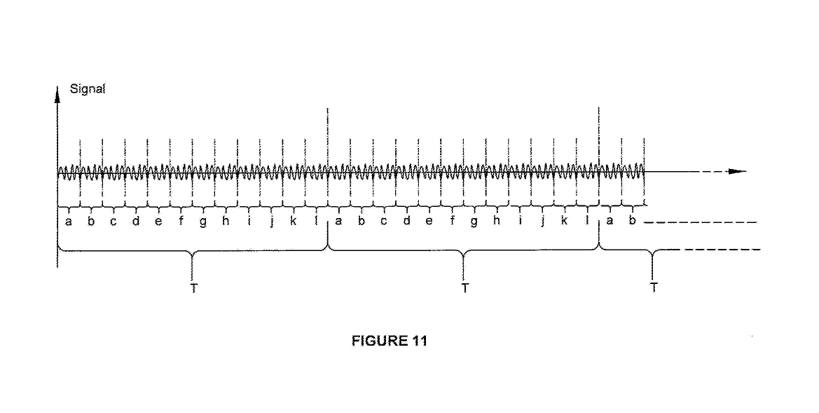

Generally, the emitter units 16-26 each generate a radio signal of suitable frequency, such as 960 MHz, this being the same for each. The signals are independently generated at each emitter unit. Referring to FIG. 11, transmissions of radio signals from the emitter units 16-26 are effected in repetitive time cycles T. Within each cycle, the emitter units each transmit one at a time in a predetermined order for respective similar fixed time periods, a, b, c, d, e, f, g, h, i, j, k, l. It does not matter what order in which transmissions are so effected, save that order should be identifiable at the receiver unit 14. Conveniently, this is effected under processor control within each emitter unit, the receiver unit being programmed accordingly to similarly identify transmissions. The receiver unit 14 receives the signals from the emitter units in turn at the utilized antennae 52 in array 54. So received signals from respective emitter units are separately processed at a processor 56 at receiver unit 14. For each received transmission from a emitter unit, the processor compares signal derived from one of the antennae 52, a reference antenna, with signal derived from each of the other four antennae 52 to determine four respective time differences between time of arrival of emitter unit signal at the reference antenna and at respective ones of the other four antennae. That is, the four time differences are:
a) between the times of arrival of signal at the reference antennae 52 and a second one of the antennae 52,
b) between the times of arrival of signal at the reference antennae 52 and a third one of the antennae 52,
c) between the times of arrival of signal at the reference antennae 52 and a fourth one of the antennae 52, and
d) between the times of arrival of signal at the reference antennae 52 and a fifth one of the antennae 52.

From these differences, the processor 56 computes the relative three-dimensional spatial disposition of the relevant emitter unit with respect to the reference antennae. For each transmission cycle, this process is repeated successively for each transmission from the emitter units, to repetitively provide determinations of the positions of each emitter unit. This information is thus cyclically updated for each cycle of received transmission from the emitter units. In this way, information as to the relative three-dimension disposition of the wrists, shoulders, and ankles of the wearer of the apparatus 10 is generated and successively updated.

In this described embodiment of the invention, in addition to providing positional information about the parts of body of the user, velocity information is generated by detecting Doppler shift in the signals from the emitter unit and received at the receiver unit 14. Further, the emitter units each include an inertial measurement unit (“IMU”) 96, having an accelerometer, a gyroscope and a magnetometer for capture and transmission to the receiver unit of information concerning the orientation of the respective emitter unit with respect to a global reference frame.

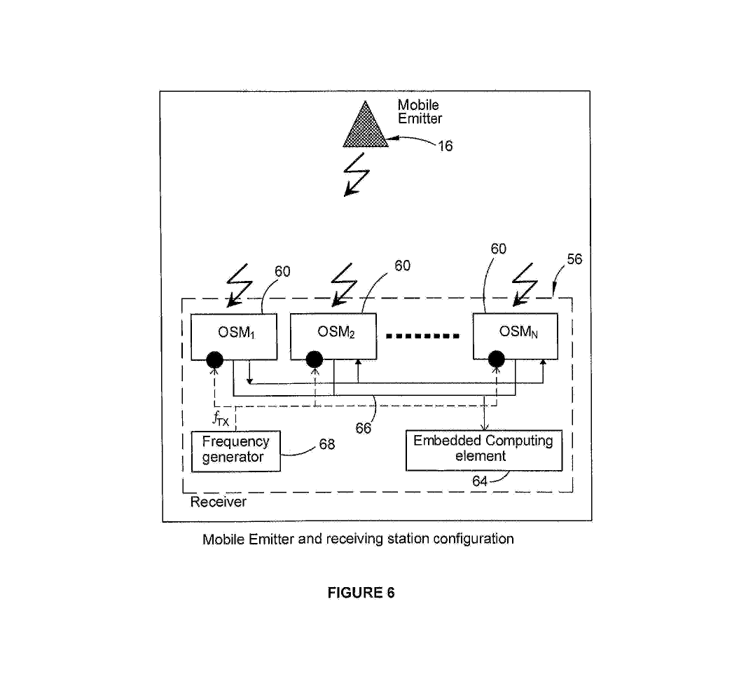

FIG. 6 shows one emitter unit 16 and components in the processor 56 of receiver unit 14. The receiver unit includes offset signal measurement devices 60 designated as OSM₁, OSM₂, . . . OSMₙ, in FIG. 6. There is one device 60 for each utilized antenna 52, in this case, then, five of these, so n=5. Receiver unit 14 includes a computing element 64 connected to the devices 60 by a bus 66 for communications transfer between devices 60 and the computing element 64. Processor 56 also includes a frequency generator 68 generating oscillatory sinusoidal signal of frequency f_{TX}.

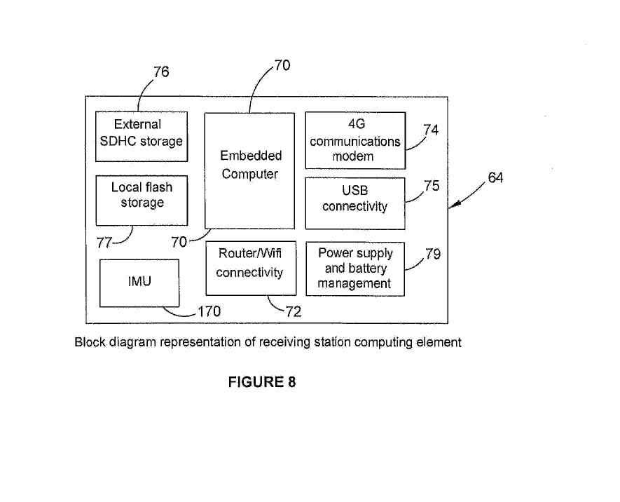

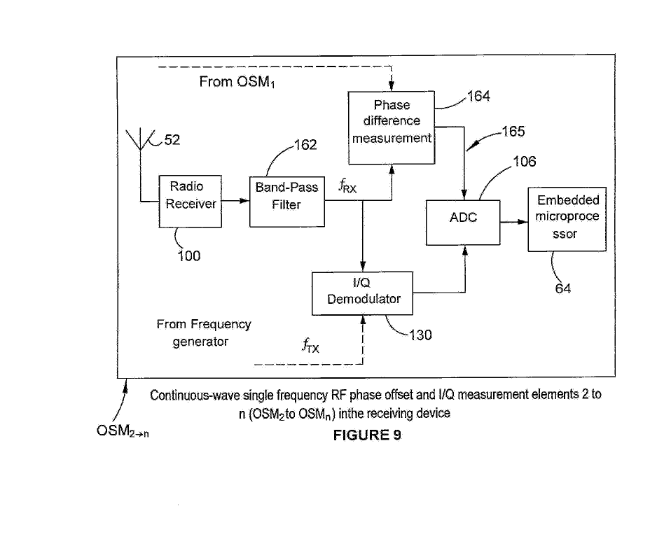

FIG. 8 shows elements of the computing element 64. This includes an embedded computer 70, a Wifi communications module 72, 4G communications modem 74, USB port 75, SDHC storage 76, local flash storage 77, and power supply and battery management unit 79.

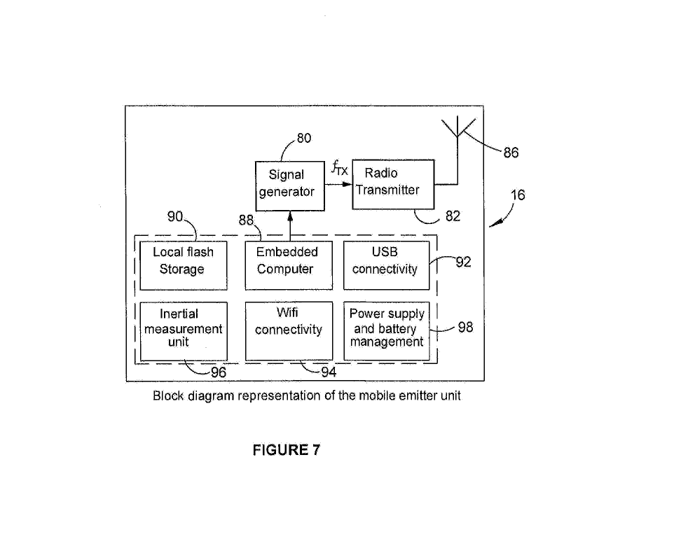

The emitter units 16-26 are each similar, unit 16 being shown, for example, in FIG. 7. The depicted emitter unit includes a signal generator 80 generating a fixed frequency sinusoidal signal f_{TX}, that is, of the same frequency as that generated by generator 68. Signal from generator 80 is passed to a radio transmitter 82 for propagation as a radio signal via an antenna 86.

Emitter unit 16 also includes an embedded computer 88 for controlling the signal generator and also performing other control functions. It is particularly arranged to cause the radio transmitter 82 to propagate radio signal via antenna 86 only during a particular period in each above mentioned time cycle which is allocated to the particular emitter unit, as described. Additional components of the depicted transmitter are local flash storage 90 for e.g. storing data concerning transmissions, a USB port 92 for transfer of data to and from the emitter unit, a Wifi module 94 for communication to and from the emitter unit and external devices, an inertial measurement unit 96 and a power supply and battery management unit 98.

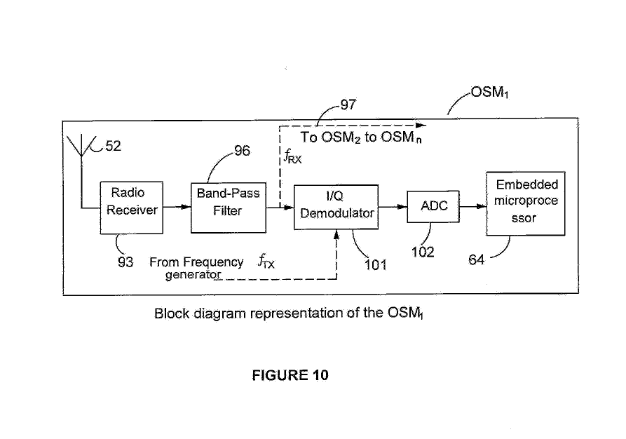

OSM₁ of FIG. 6 constitutes a reference offset signal measurement device and it is further illustrated in FIG. 10. It has a radio receiver 93 which receives radio frequency signal from one antenna 52 in the array 54, the signal being derived from received radio transmission from the emitter units. The so derived signal is passed through a band-pass filter 96 to remove unwanted signal components and thence to output 97 from the OSM₁ to the OSM₂, . . . OSMₙ.

FIG. 9 illustrates one of the OSM₂ . . . OSMₙ, these being similar. This includes a radio receiver 100 connected to a respective one of the antennae 52 of array 54. Radio signal from the emitter units 14 is received at antennae 52 and passed to generate a corresponding radio frequency signal to receiver 100 the output of which passes through a band-pass filter 102 to a phase difference measurement unit 104 which also receives the output from the OSM₁. The resultant output 165 from the unit 104 represents the difference between times of arrival of signal from an emitter unit 16-26 at the antenna 52 to which the respective OSM₂ . . . OSMₙ is connected, with respect to the time of arrival at the antenna 52 to which OSM₁ is connected. This difference is converted to digital form at an analogue-digital converter 106 and passed to computing element 64.

Computing element 64 receives output from the A/D converters 106 of each of the OSM₂ . . . OSMₙ and on the basis of these computes the position of the respective and emitter unit. During each of the mentioned operation cycles, this computation is successively made for each emitter unit.

Provision is made for synchronisation of the radio transmissions from the emitter units 16-26. At turn-on of the apparatus, signal is sent from receiver unit 14 to the emitter units to initialise operation. Responsive to this, cyclic transmissions from the respective emitter units is executed as described, the emitter units transmitting once in each cycle, each during a respective different predetermined time slot within a cycle T, in a predetermined sequence, in accordance with program information which is stored in the receiver. Through this programming, the positional information sent from the OSMs devices 60 can be uniquely associated with particular receiver units. Since the signal generators in the units are free running, is possible that drift will occur over time. To compensate for this, each emitter unit 16-26 is able to receive signal transmissions from the others and detection circuitry is included in these, such that in the event of accumulated drift in transmission times of the emitter during each cycle T of operation reaches a predetermined level, signal is sent to the receiver unit 14 to reset and reinitialise operation of the emitter units.

Referring to FIG. 10, OSM₁ includes an I/Q demodulator 101 which receives signal at frequency f_{TX} from the generator 68 (FIG. 6), as well as output from band pass filter 96. The demodulator 101 produces an output indicative of a spatial component of velocity of the transmitting emitter unit as evidenced at the associated antennae 52. The demodulated signal is converted to digital form at A/D converter 102 and passed to computing element 64. At each OSM₂, . . . OSMₙ, signal from signal generator 68 (FIG. 6) is received and passed to an I/Q demodulator 130 which also receives signal from the receiver 100 and band-pass filter 102 of that OSM, this latter being of frequency transmitted from the emitter unit for the time being processed by the OSM, and thus dependent on the velocity of that emitter unit. The I/Q demodulator 130 produces an output indicative of a spatial component of velocity of the transmitting emitter unit as evidenced at the associated antennae 52. This output is passed to the A/D converter 106 of the OSM and thence in digitised form to the computing element 64. Similarly, at the OSM₁. From the digitised outputs of the I/Q demodulators in the OSMs, the computing element 64 computes the vector velocity of the for the time being transmitting emitter unit 16-26, this being repeated within each aforementioned operational cycle for each emitter unit.

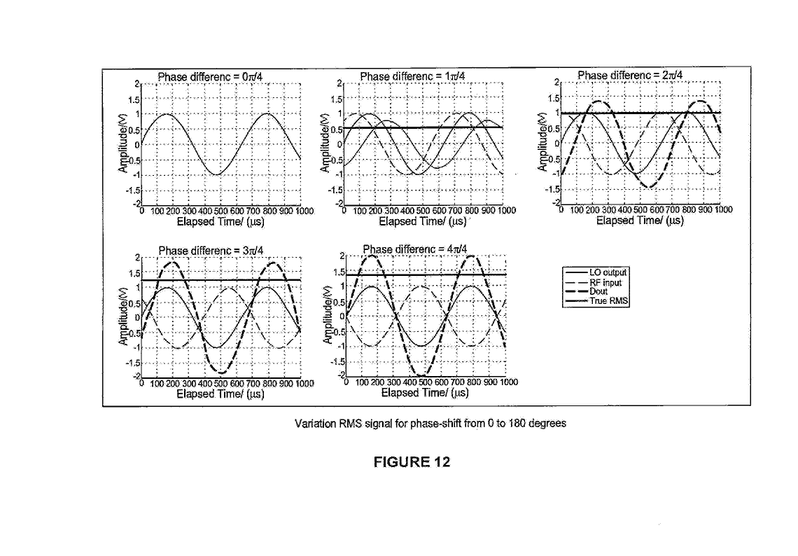

The computation of the phase shift between the signals received at pairs of antennae 52, as described, may be accomplished by any suitable process. FIG. 12 shows graphically, two sinusoidal signals “LO output” and “RF output” of the same frequency for various different phase displacements between these. As illustrated at “Dout” the result of combining these signals is a sinusoidal signal of the same frequency but of amplitude dependent on the relative phase displacement, such that detecting the RMS value of this provides an output representative of the phase change. This technique may be used in the computing element 64 for establishing the phase differences (times of arrival) of signals at the antenna, as comparisons between a reference signal, derived from one antennae 52 and the signal obtained from each other antennae 52.

The described I/Q demodulators may be of usual form, operating on the basis that frequency variations arising in a carrier signal may be treated as phasors, having in-phase and quadrature components capable of being decoded to provide information as to the frequency variations.

The information derived by the apparatus 10 as generated at computing element 64 may be presented in any convenient form, for example, for external transmission via communications modem 74, or writing to the SDHC card 76 at the receiver unit.

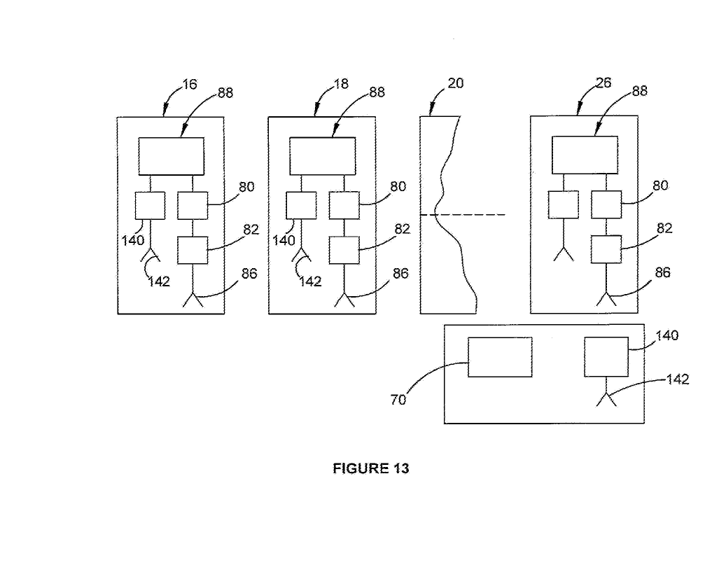

Communications between the receiver unit 14 and the emitter units 16-26, for control of apparatus 10, and between the emitter units themselves, also for control purposes, is achieved by radio transmissions between these, separate from transmissions for determining positional and velocity information. In particular, FIG. 13 shows the emitter units 16-26 and the receiver unit 14 as each having a radio transceiver 140, connected to a respective antenna 142 for this purpose and also connected to the respective embedded computer 88 or computer 70. Under control of computer 70, transceiver 140 of receiver unit 14 transmits the mentioned initialisation signal to the emitter units via its antenna 142 to begin operation and also the rest-signal to resynchronise operation once a signal is received from an emitter unit indicative that an allowed drift in transmissions has been reached. The transceivers 140 in the emitter units are also used to transmit signals between the emitter units for purposes of determining drift. Particularly, although the sequence for transmission of signals from the emitter units 16-26, (for use in determining position and velocity), within each time period T is separately programmed in the computer element 88 of each emitter unit, each emitter unit 16-26 also receives via its transceiver 140 and antenna 142 signal so sent by each other emitter unit 16-26. The computing elements 88 of the emitter units are programmed to detect whether the preceding emitter unit is still transmitting at the time that emitter unit is programmed to begin transmission, and to delay beginning of transmission until the preceding transmission has terminated. When at time in a cycle when the last emitter unit is to transmit, the time interval is greater than a predetermined time interval, at the end of transmission by the last emitter unit, under control of computing element 88 of that emitter unit, that emitter unit transmits via its transceiver 140 and antenna 142 the mentioned signal to the receiver unit 14 to cause the receiver unit to send the re-rest signal to the emitter units. The re-set signal is received by the receiver units, and the emitter units are responsive to receipt of the re-set signal to re-set transmission. The reset process, under control of the computer elements 88 involves synchronising each emitter unit so that these are reprogrammed to begin transmissions in sequence at the respective predetermined start times in each transmission cycle.

The following describes a specific implementation of the invention. In this, the term “tag” refers to an emitter 16-26. Gyros, magnetometers and accelerometers as incorporated into the IMUs 96 unless otherwise indicated.

1. Localization of a Tag with Respect to the Belt

As mentioned, a minimum of five non-coplanar receivers are positioned in the belt to localize the mobile tag. The time delays are calculated using the phase difference of arrival.

The localization is the mobile tag may be achieved as follows:

Let P=[x y z]^{T} denotes the position of the mobile tag. And the known positions of the receiver stations on the belt be S₀,Sᵢ,Sⱼ,Sₖ and Sₗ. If c indicate the speed of RF wave propagation, and τᵢ indicate the time delay of arrival at receiver i ∈ {i,j,k,l} with respect to the reference receiver 0.

2cτᵢ∥P∥=∥Sᵢ∥²−2S|P−c²τᵢ²

Let

S=[sᵢ sⱼ sₖ]^{T} and τ=[τᵢ τⱼ τₖ]^{T}. The system of equations can be written in the following form:

$$P = 0.5 [ {S}^{- 1} + c ρ {S}^{- 1} τ {s}_{i}^{T} {S}^{- 1} - c ρ {S}^{- 1} τ ] u \\ where \\ ρ = \frac{1}{d} , d = c {τ}_{i} - {cs}_{i}^{1} {S}^{- 1} τ , \\ {u}_{n} = {‖ s ‖}^{n} - {c}^{2} {τ}_{n}^{2} , u = {[ \begin{matrix}{u}_{i} & {u}_{j} & {u}_{k} & {u}_{l}\end{matrix} ]}^{T} . \qquad ( 1 )$$

The overall global coordinate system is the one at s₀.

2. Orientation of the Tag with Respect to the Belt

This section describes how information from IMUs incorporated in the emitters 16-26 can be utilised to determine orientation of a tag with respect to belt 14.

(a) Rotation Matrix from Magnetometer Reading

Let the Magnetometer reading in the tag's frame be Mₜ and in the Belt frame be M_{b}. The rotation matrix then given by (Rodrigue's formula)

$${R}_{M}^{t} = {I}_{3} cos θ + {N}_{+} + {NN}^{T} ( 1 - cos θ ) \\ where \\ {N}_{+} = [ \begin{matrix}0 & - {N}_{3} & {N}_{2} \\ {N}_{3} & 0 & - {N}_{1} \\ - {N}_{2} & {N}_{1} & 0\end{matrix} ] , \\ cos θ = {M}_{t} ⊙ {M}_{b} , N = [ \begin{matrix}{N}_{1} \\ {N}_{2} \\ {N}_{3}\end{matrix} ] = \frac{{M}_{t} ⊗ {M}_{b}}{‖ {M}_{t} ‖ ‖ {M}_{b} ‖} \qquad ( 2 )$$

with ⊙ and [symbol] indicating the dot and the cross product respectively and R_{M}^{t} is the rotation matrix at time t.

(b) Rotation Matrix from Gyro Readings

Let the Gyro reading be: [\dot{θ}ₓ \dot{θ}_{y} \dot{θ}_{z}] and the sampling time be τ. Then rotation matrix estimated from Gyros be:

R_{G}^{t+1}=S_{θ}_{_{z}}^{t+1}S_{θ}_{_{y}}^{t+1}S_{θ}_{ₓ}^{t+1}

where, θₓ=\dot{θ}ₓτ, θ_{y}=\dot{θ}_{y}τ, θ_{z}=\dot{θ}_{z}τ. And S_{θ}_{ₓ}^{t+1} indicates the rotation matrix with a rotation of θₓ around x axis. This rotation matrix is deducted purely from Gyroscopic readings.

(c) Progressive Rotation Matrix Fusion

Overall rotation matrix: R^{t+1}=(W(t)R_{M}^{t+1}+R_{G}^{t+1})/(W+1) with W(t) is a time varying weighting matrix with lower weighting when t is small.

3. Progressive Transmitter Filtering for Position Refinement.

This section describes filtering to refine the position of a tag by use of a Kalman filter.

Position deduced from (1) transformed into the Belt co-ordinate system from the Rotation estimations from (2). The acceleration measurements in the transmitter from are also transformed to the Belt frame (with Belt measured accelerations deducted). Then the measurement input to the Kalman filter is [x y z \ddot{x} ÿ \ddot{z}], position and acceleration of the transmitter. The output of the Kalman filter is the refined state consisting the position, velocity and the accelerations (see references [1] and [2] below mentioned).

4. Position and Orientation Estimation of the Belt Initialization Phase

At start-up, the position and orientation of the belt may be determined, as a reference, in the following manner:

The system (receiver unit 14) is kept at a still position and the gravity (from accelerometers) is used to find the direction of ground and the initial co-ordinate frame position is established.

Progressive Estimation of Orientation and Position

Orientation is progressively estimated as in (2) with respect to the original position and orientation and the position is deduced from the accelerometer reading of the belt (similar to (3) but without position readings.

### REFERENCES

[1] Pathirana, P. N., Savkin, A. V., Ekanayake, S. W., Bauer, N. J., “A Robust Solution to the Stereo-Vision Based Simultaneous Localization and Mapping Problem with Steady and Moving Landmarks”, Advanced Robotics, 25(6-7):765-788, 2011.

[2] Pathirana, P. N and Herath, S. C. K and Savking, A. V. “Multi-target Tracking via Space Trans-formations Using a Single Frequency Continuouse Wave Radar”, IEEE Transaction of Signal Processing, Accepted on the 7 Jun., 2012.

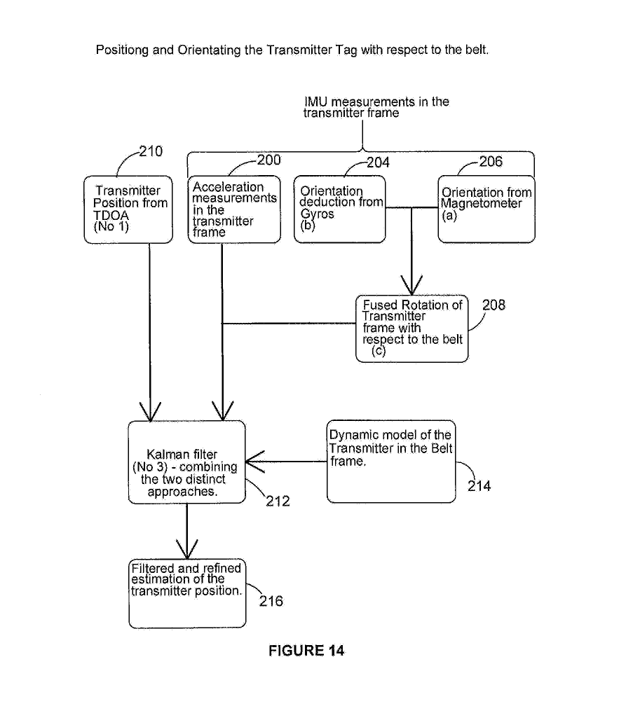

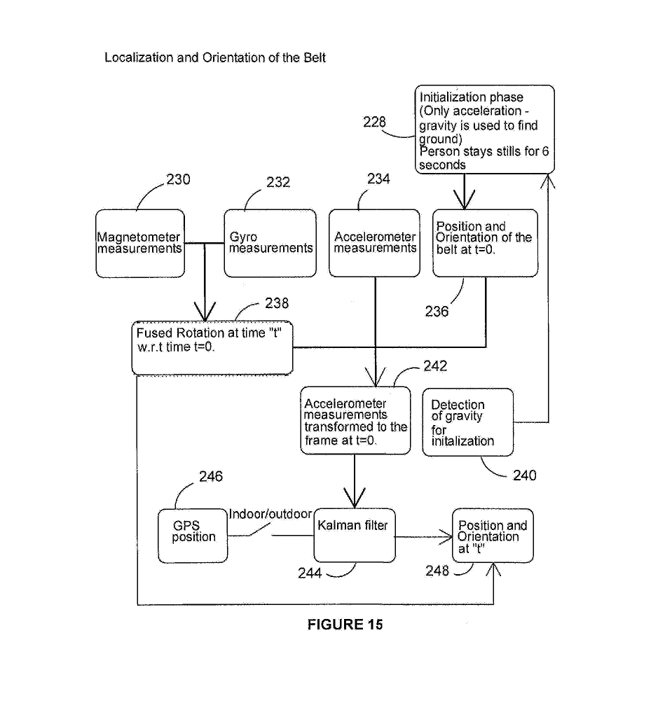

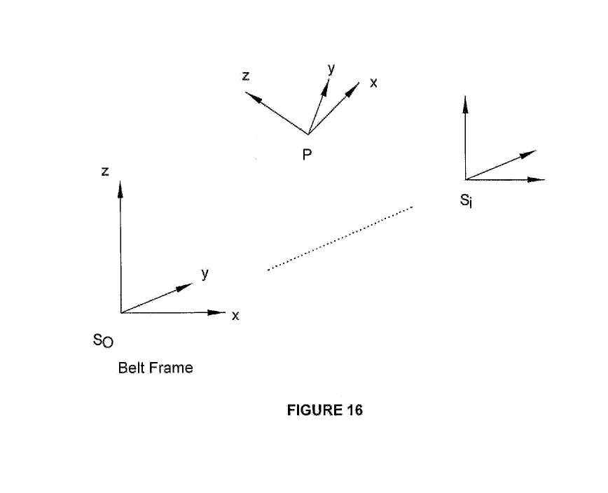

The operations above described are summarised in FIGS. 14 and 15.

Referring to FIG. 14, and the description under 1 and 2 above, at an emitter 16-26, the IMU 96 thereof generates acceleration measurements 200 in the emitter frame, orientation information 202 from gyroscopes and orientation information 204 from a magnetometer. At the emitter embedded computer 88, the orientation information from the gyroscopes is fused with the orientation information from the magnetometer to produce an output 208 representing the fused rotation of the emitter transmitter frame with respect to the belt frame (at belt 14). The latter information together with the acceleration measurements 200 is radio transmitted by the emitter to the belt 14, and is used to refine the time of arrival computations made at the belt by embedded computing element 64. To this end, the computed time delay of arrival information 210 as initially computed by the embedded computer as previously described is applied to a Kalman filter 212 together with the acceleration measurement 200 and the fused rotation information 208. Kalman filter 212 operates recursively on the supplied information to refine the positional information 210, with reference to a pre-stored dynamic model 214 of the belt frame.

FIG. 15 illustrates how magnetometer, gyroscopic and accelerator measurements, 230, 232 and 234 from an IMU 170 (FIG. 8) included in receiver unit 14 may be utilized to obtain the location and orientation of belt 15. This information is at the belt combined with information 236 describing the position and orientation of the belt time t=0. That information may for example be derived from a magnetometer in IMU 170 obtained by maintaining the belt at a fixed location and orientation for a predetermined time, such as a few seconds and by use of detected gravity, 240, to provide the direction to ground.

Fused magnetometer and gyroscopic measurements 230, 232 are applied at belt 15 together with the information 236 to produce fused rotation information 238 relating to the emitter at time t=0.

Accelerator measurements 234 at time t=0 are separately applied to a Kalman filter 244 and the output of filter 238, together with the fused rotation information 248, to produce position and orientation information 248. Additionally, GPS information may be applied to filter 244, particularly in outdoor situations where a satisfactory GPS signal is present.

The disclosures of the aforementioned references [1] and [2] are hereby incorporated to form part of the disclosures of this specification.

The use of data derive from accelerometers, gyroscopes and magnetometers as described at 200, 204, 206 in FIG. 14 and 234, 232, and 230 in FIG. 5 to provide input to the Kalman filters 212, 214 in these figures including the deriving of the fuse rotation information 208, 238 may be accomplished by known processes, for example as described at:
Rong Zhu and Zhaoying Zhou: A Real-Time Articulated Human Motion Tracking Using Tri-Axis Inertial/Magnetic Sensors Package, IEEE Transactions On Neural Systems And Rehabilitation Engineering, Vol. 12, No. 2, June 2004,

the disclosures of which are hereby incorporated to form part of the disclosures of this specification.

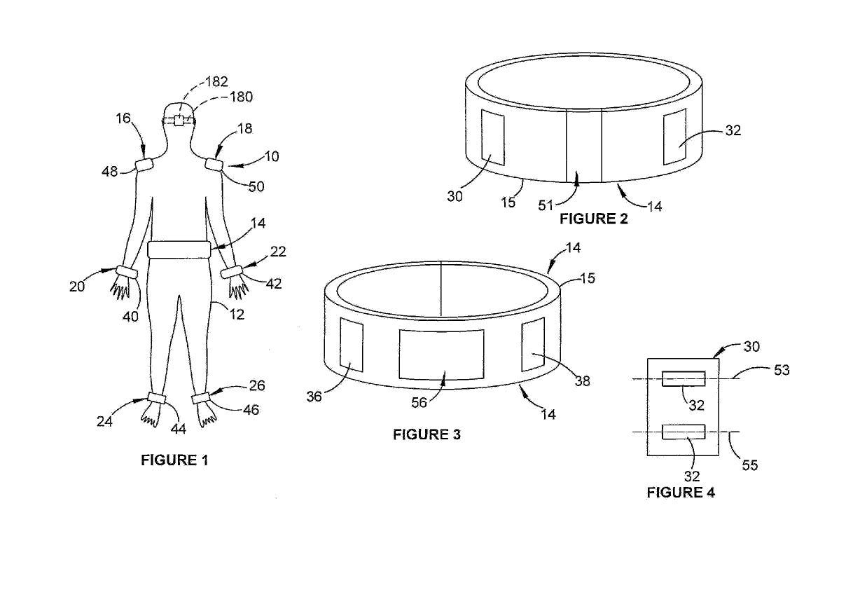

In the described embodiment six emitter units 16-26 are utilised, positioned as shown in FIG. 1, at the shoulders, wrists and ankles of the user. This arrangement has been found to be very satisfactory in enabling tracky of the position of parts of the human body relevant to e.g. diagnosis of human conditions. However, depending on the relevant application, fewer or more emitters may be used, and/or they may be differently positioned. For example, FIG. 1 shows an additional emitter unit 180 is shown attached to a head band 182 positioned on the user's head, to enable tracking of the position of the user's head.

In the described embodiment, the emitters transmit signal at a single frequency.

The method of the invention is particularly advantageous because, by using the time difference of arrival of signal from an emitter for localisation of the emitter, significant immunity to error in the relevant data may be conferred. Performance in that regard is likewise improved by described additional use of accelerometer, gyroscopic and magnetometer information as illustrated in FIG. 14.

The described construction has been advanced merely by way of example and many modifications and variations may be made without departing from the spirit and scope of the invention, which includes every novel feature and combination of features herein disclosed.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

The reference in this specification to any prior publication (or information derived from it), or to any matter which is known, is not, and should not be taken as an acknowledgment or admission or any form of suggestion that that prior publication (or information derived from it) or known matter forms part of the common general knowledge.

### PARTS LIST

10 apparatus

12 user

14 receiver unit

15 belt

16, 18, 20, 22, 24, 26 emitter units

30, 32, 34, 36 elements

40, 42, 44, 46 ankle bands

48, 50 connector

52 radio antennae

53 first plane

54 array

55 common plane

56 processor

60 measurement device

64 computing element

68 generator

70 computing elements

72 communications module

74 modem

75, 92 USB port

76 SDHC storage

77 flash storage

79 management unit

80 signal generator

82 radio transmitter

86 antenna

88 computing element

90 flash storage

94 Wifi module

100 receiver

101 I/Q demodulator

102 band-pass filter

104 measurement unit

106 A/D converters

130 I/Q modulator

140 radio transceivers

142 antenna

170, 96 IMU

200 measurements

202, 204 orientation information

208 rotation information

210 arrival information

212 filter

230, 232, 234 accelerator measurements

236 information

238, 244 filter

248 rotation information

1. Apparatus for detecting position of a part of the body of a human user, the apparatus having a wearable emitter unit adapted to be worn by the user at a location adjacent said part of the body of the user, having a radio transmitter for generating and propagating radio signal from the emitter unit, and a receiver unit, the receiver unit having:
a) radio receiver means for receiving radio signal from the emitter unit;
b) at least five spatially separated antennae for receiving the radio signal, not all disposed in a single plane; and
c) computing means for detecting differences between times of arrival of said signal at ones of four different pairs of said antennae and determining from the detected differences the three-dimensional position of said emitter unit with respect to the receiver unit.

2. Apparatus as claimed in claim 1 wherein the emitter unit is one of a plurality of emitter units adapted to be worn by the user each at a respective said location adjacent a respective part of the body of the user, each having a said radio transmitter for generating and propagating a respective said radio signal from the emitter unit, the computing means of the receiver unit for detecting differences between times of arrival of each said signal at ones of said four different pairs of said antennae and determining from the detected differences the three-dimensional position of the respective emitter unit with respect to the receiver unit.

3. Apparatus as claimed in claim 2, wherein the emitter units are controlled to in use transmit for successive different time periods in repetitive cycles of operation of the apparatus.

4. Apparatus as claimed in claim 3 wherein the emitter units each include means for detecting whether the emitter unit transmitting immediately before that emitter unit is still transmitting when the said time period allocated to that emitter unit for transmission in said cycle commences, and delaying transmission from that emitter unit until the preceding emitter unit ceases transmission.

5. Apparatus as claimed in claim 4 wherein at least one said emitter unit has means for detecting the delay between beginning of transmission therefrom, and the beginning of the allocated time within a said cycle at which that emitter unit is to begin transmission, and for generating a signal in the case where that delay reaches a predetermined amount, the receiver means being arranged to receive that signal and be responsive to receipt thereof, to transmit a re-set signal, the emitter units including means responsive to receipt of the re-set signal to synchronise each emitter unit for transmission at respective said allocated periods in each said cycle.

6. Apparatus as claimed in claim 5 wherein said at least one emitter unit is the last to transmit during a said cycle.

7. Apparatus as claimed in claim 1 including means for determining relative velocity of the or each emitter unit by comparison of the frequency of transmission of said radio signal compared to a reference frequency.

8. Apparatus as claimed in claim 1, the or at least one said emitter unit having an inertial measurement unit for providing positional information as to the position of the emitter unit, and means for transmitting that information to the receiver unit, the receiver unit having means for receiving the positional information and the apparatus having means for combining the positional information with information as to the position of the emitter unit determined from said detected differences to provide a refined position of the or the at least one emitter unit.

9. Apparatus as claimed in claim 8 having a Kalman filter arranged to effect said combining.

10. Apparatus as claimed in claim 9 wherein the information as to the position is acceleration information, gyroscopic information and magnetometer information, the gyroscopic information and the magnetometer information being fused and combined with the acceleration information for application to the Kalman filter.

11. Apparatus as claimed in claim 1, the receiver unit having an inertial measurement unit, means being provided for determining from information deriving from the inertial measurement unit a reference location of the receiver unit.

12. Apparatus as claimed in claim 1 wherein the receiver unit is wearable by the user.

13. Apparatus as claimed in claim 1 wherein the receiver unit includes a belt wearable by the user to support the receiver unit on the user.

14. A method of detecting position of a part of the body of a human user, in which a wearable emitter unit and a wearable receiver unit are worn by the user, the emitter unit being worn by at a location adjacent said part of a body of the user, the method including:
a) propagating a radio signal from the emitter unit;
b) receiving the propagated radio signal at least five antennae of the receiver unit, not all antennae being in the same plane,
c) determining the differences in times of arrival of said radio signal at ones of four different pairs of said antennae; and
d) determining from the detected differences the three-dimensional position of said emitter unit with respect to the receiver unit.

15. A method as claimed in claim 14 wherein the emitter unit is one of a plurality of emitter units adapted to be worn by the user each at a respective said location adjacent a respective part of the body of the user, propagating a said radio signal from each emitter unit, detecting differences between times of arrival of each said signal at ones of four different pairs of said antennae and determining from the detected differences the three-dimensional position of the respective emitter unit with respect to the receiver unit.

16. A method as claimed in claim 15, wherein the emitter units are controlled to in use transmit for successive different time periods in repetitive cycles of operation of the apparatus.

17. A method as claimed in claim 16, including detecting whether an emitter unit transmitting immediately before a next to transmit emitter unit is still transmitting when the said time period allocated to the next to transmit emitter unit commences, and delaying transmission from that next to transmit emitter until the preceding emitter unit ceases transmission.

18. A method as claimed in claim 16, including detecting the delay between beginning of transmission by at least one emitter unit, and the beginning of the allocated time within a said cycle at which that emitter device is to begin transmission, and generating a signal in the case where that delay reaches a predetermined amount, the receiver means being arranged to receive that signal and be responsive to receipt thereof to transmit a re-set signal, the emitter units being responsive to receipt of the re-set signal to synchronise themselves for transmission at respective said allocated periods in each said cycle.

19. A method as claimed in claim 18, wherein said at least one emitter unit is the last one to transmit in each said cycle

20. A method as claimed in claim 14 including determining relative velocity of a said emitter unit by comparison of the frequency of transmission of said radio signal transmitted therefrom, compared to a reference frequency.

21. A method as claimed in claim 14, a first said emitter unit having an inertial measurement unit for providing position information as to the position of the first emitter unit, the method including transmitting that information to the receiver unit, and combining the transmitted positional information with information as to the position of the first emitter unit determined from said detected differences to provide a refined position of the first emitter unit.

22. A method as claimed in claim 21 wherein the information as to the position is acceleration information, gyroscopic information and magnetometer information, the gyroscopic information and the magnetometer information being fused and combined with the acceleration information for application to the Kalman filter

23. A method as claimed in claim 21 wherein said combining is effected by a Kalman filter.

24. A method as claimed in claim 14, the receiver unit having an inertial measurement unit, means being provided for determining from information deriving from the inertial measurement unit a reference location of the receiver unit.

25. A method as claimed in claim 14, wherein the receiver unit is worn by the user.

26. A method as claimed in claim 24, wherein the receiver is in the form of a belt worn by the user.

27. The apparatus of claim 1 wherein the or each emitter unit is arranged for transmission of said radio signal as a single frequency signal.

28. The method of claim 14 wherein the radio signal propagated from the or each emitter unit is a single frequency signal.

29. A computer program including a plurality of instructions for execution by one or more processors of a computer system, said program when executed by the one or more processors cause the computer system to perform the method claimed in claim 14.

30. Non-transitory computer readable data storage including the computer program claimed in claim 29 stored thereon.
